(19) United States
(12) Patent Application Publication
(10) Pub. No.: US 2018/0160479 A1
(43) Pub. Date: Jun. 7, 2018

(54) SHEET HEATER INCLUDING PATTERN ELECTRODES AND HEATING APPARATUS HAVING THE SAME

(71) Applicant: Samsung Electronics Co., Ltd., Suwon-si (KR)

(72) Inventors: Jinhong Kim, Seoul (KR); Changsoo Lee, Seoul (KR); Doyoon Kim, Hwaseong-si (KR); Haengdeog Koh, Hwaseong-si (KR); Seyun Kim, Seoul (KR); Hajin Kim, Hwaseong-si (KR); Soichiro MIZUSAKI, Suwon-si (KR); Minjong Bae, Yongin-si (KR); Hiesang Sohn, Seoul (KR)

(21) Appl. No.: 15/830,213

(22) Filed: Dec. 4, 2017

(30) Foreign Application Priority Data
Dec. 5, 2016 (KR) 10-2016-0164388

(51) Int. Cl. H05B 3/10; A21B 1/22; H05B 3/32

(52) U.S. Cl. CPC H05B 3/10; H05B 3/32; A21B 1/22

(57) ABSTRACT

A sheet heater includes a substrate; a first and second finger electrode each on the substrate to lengthwise extend in a first direction and be spaced apart from each other in a second direction; and a heating layer on the substrate to have a stripe shape lengthwise extended in the second direction to cross each of the first and second finger electrodes. The first finger electrode or the second finger electrode crossed by the heating layer is a pattern electrode in which an opening is defined, for the pattern electrode in which the opening is defined, an opening ratio is defined by a total planar area of the opening to a total planar area of the pattern electrode, and the opening ratio is in a range from about 40% to about 80%.

### CROSS-REFERENCE TO RELATED APPLICATION

This application claims priority to Korean Patent Application No. 10-2016-0164388, filed on Dec. 5, 2016, and all the benefits accruing therefrom under 35 U.S.C. § 119, the content of which in its entirety is herein incorporated by reference.

### BACKGROUND

### 1. Field

The present disclosure relates to sheet heaters including pattern electrodes and electric ovens including the sheet heaters.

### 2. Description of the Related Art

A heating layer of a sheet heater has a plate shape unlike a coil heater. The sheet heater having the heating layer with the plate shape directly contacts an object to be heated, and thus, a heat conduction efficiency of the sheet heater is increased.

In general, electrodes of a sheet heater have a flat shape or a line shape. When a heating layer is disposed or formed on the electrodes, stress is generated at a contact surface between the flat or line shaped electrodes and the heating layer due to a thermal expansion coefficient difference between the electrodes and the heating layer.

### SUMMARY

Provided is a sheet heater including pattern electrodes configured to reduce a contact surface between a heating layer of the sheet heater and the electrodes thereof.

Provided is a heating system or apparatus, such as an electric oven, including the sheet heater.

According to an embodiment, a sheet heater of a heating apparatus includes: a substrate within the heating apparatus, the substrate disposed in a plane defined by first and second directions which cross each other; a first electrode including a first finger electrode which is on the substrate to lengthwise extend in the first direction; a second electrode including a second finger electrode which is on the substrate to lengthwise extend in the first direction, the second finger electrode spaced apart from the first finger electrode in the second direction; and a heating layer in which heat is generated, the heating layer on the substrate to have a stripe shape lengthwise extended in the second direction to cross each of the first finger electrode and the second finger electrode. The first finger electrode or the second finger electrode crossed by the heating layer is a pattern electrode in which an opening is defined. For the pattern electrode in which the opening is defined, an opening ratio is defined by a total planar area of the opening to a total planar area of the pattern electrode, and the opening ratio is in a range from about 40% to about 80%.

The pattern electrodes may have a mesh shape.

The pattern electrode may include Ag, Pt or Pd.

According to an embodiment, the first electrode and the second electrode may respectively include the first finger electrode and the second finger electrode provided in plurality, the plurality of the first and second finger electrodes alternated with each other in the second direction, and the heating layer may be provided in plurality on the substrate. Each heating layer may cross only one of the plurality of first finger electrodes and only one of the plurality of second finger electrodes.

The pattern electrode may have a thickness in a range from about 10 micrometers (μm) to about 20 μm.

The heating layer may include a conductive filler sheet provided in plurality configured to form an electrical current path, and a matrix in which the plurality of conductive filler sheets are disposed, the matrix including a glass frit or an organic polymer.

The plurality of conductive filler sheets in the heating layer of the sheet heater defines a maximum dimension from about 1 μm to about 2 μm.

The heating layer may have a thickness in a range from about 5 μm to about 50 μm.

The conductive filler sheets may include RuO₂, MnO₂, ReO₂, VO₂, OsO₂, TaO₂, IrO₂, NbO₂, WO₂, GaO₂, MoO₂, InO₂, CrO₂ or RhO₂.

The conductive filler sheets may each include RuO₂ and a content of the plurality of conductive filler sheets each including RuO₂ may be in a range from about 0.6 volume percent (vol %) to about 1.0 vol % with respect to a total volume of the heating layer.

According to an embodiment, a heating system includes: a case of a heating apparatus of the heating system, the case having a rectangular box shape in which a front face thereof includes an opening through which an object to be heated is accommodated; an inner frame in the case, the inner frame defining a cavity in which the object to be heated is accommodated; and a sheet heater mounted on an external side of the inner frame, the external side facing the case. The sheet heater includes on the external side of the inner frame: an insulating layer on the inner frame; a first electrode including a first finger electrode which is on the insulating layer to lengthwise extend in a first direction; a second electrode including a second finger electrode which is on the insulating layer to lengthwise extend in the first direction, the second electrode spaced apart from the first electrode in a second direction which crosses the first direction; and a heating layer in which heat is generated, the heating layer on the substrate to have a stripe shape lengthwise extended in the second direction to cross each of the first finger electrode and the second finger electrode. The first finger electrode or the second finger electrode crossed by the heating layer is a pattern electrode in which an opening is defined. For the pattern electrode in which the opening is defined, an opening ratio is defined by a total planar area of the opening to a total planar area of the pattern electrode, and the opening ratio is in a range from about 40% to about 80%.

### BRIEF DESCRIPTION OF THE DRAWINGS

These and/or other features will become apparent and more readily appreciated from the following description of the embodiments, taken in conjunction with the accompanying drawings in which:

FIG. 1 is a schematic perspective view of a structure of a heating system according to an exemplary embodiment;

FIG. 2 is a schematic top plan view showing a disposition of sheet heater of a heating system, according to an exemplary embodiment;

FIG. 3 is a cross-sectional view of a portion of the sheet heater of the heating system taken along line III-III′ of FIG. 2;

FIG. 4 is a schematic top plan view showing a structure of electrodes of a sheet heater of a heating system according to an exemplary embodiment;

FIGS. 5A and 5B are schematic top plan views respectively showing a shape of an electrode of a sheet heater of a heating system, according to other exemplary embodiments;

FIG. 6 is a cross-sectional view showing a structure of a heating layer of a sheet heater of a heating system, according to an exemplary embodiment; and

FIG. 7 is a schematic top plan view showing a disposition of sheet heater of a heating system, according to another exemplary embodiment.

### DETAILED DESCRIPTION

Reference will now be made in detail to embodiments, examples of which are illustrated in the accompanying drawings. In the drawings, thicknesses of layers and regions may be exaggerated for clarification of the specification. The exemplary embodiments of the present disclosure are capable of various modifications and may be embodied in many different forms. Like reference numerals refer to like elements throughout.

It will be understood that when an element is referred to as being related to another element such as being “on” or “above” another element, the element may be in direct contact with the other element or other intervening elements may be present. In contrast, when an element is referred to as being related to another element such as being “directly on” or “directly above” another element, the element is in direct contact with the other element or no intervening elements are present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Within a sheet heater of a heating system, stress generated at a contact surface between flat or line shape electrodes and a heating layer due to a thermal expansion coefficient difference between the electrodes and the heating layer may undesirably cause cracks or damage to the heating layer.

A heating system or apparatus such as an electric oven that uses a sheet heater may be heated to over 500 degrees Celsius (° C.). With such a heating temperature, cracks may occur in the heating layer of the sheet heater, and accordingly, the performance of the heating system or apparatus which includes the sheet heater may deteriorate.

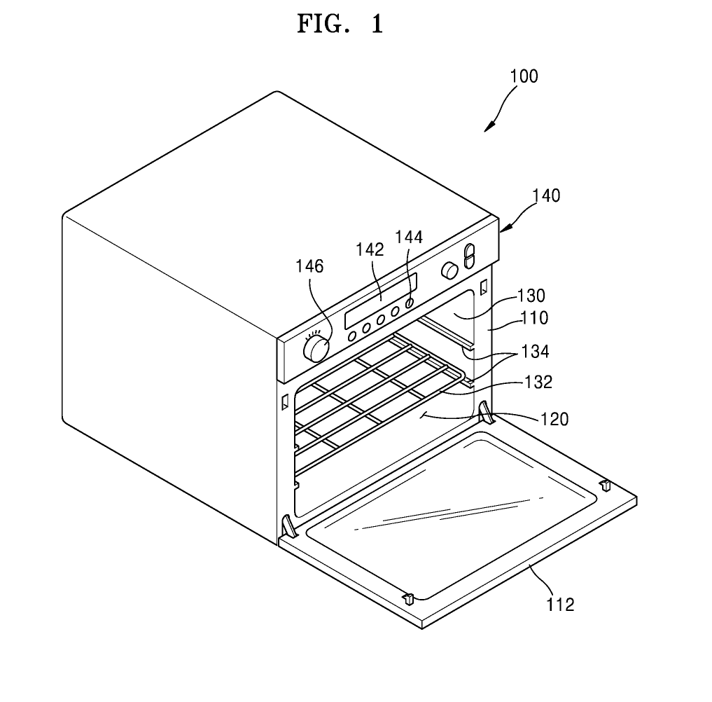

FIG. 1 is a schematic perspective view of a structure of a heating system or apparatus 100, represented by an electric oven, according to an exemplary embodiment. The heating system or apparatus 100 may hereinafter be referred to as “an electric oven 100.”

Referring to FIG. 1, the electric oven 100 includes a case 110 that forms an outer appearance thereof, and an inner frame (or case) 130 that is disposed or formed in the case 110 and defines a cavity (or a heating/cooking space) 120 at which an object is heated or cooked. The case 110 and the inner frame 130 may be spaced apart from each other, and a space between the case 110 and the inner frame 130 may be filled with an insulating material (not shown), but the invention is not limited thereto. The case 110 may have an overall rectangular box shape. An opening may be defined at a front surface of the heating system 100 and through which the cavity 120 is accessible from outside the heating system 100. The opening may be configured to be opened and closed. The case 110 may have a substantially cuboid shape.

Openings at the front surfaces of the case 110 and the inner frame 130 together define the opening of the heating system 100 so that an object to be heated such as food may transferred from outside the heating system 100 to inside the heating system 100, e.g., within the inner frame 130 at the cavity 120. A door 112 is rotatably coupled to the case 110 and/or the inner frame 130 about a hinge axis. Referring to the vertical direction in FIG. 1, the door 112 may be configured to rotate up to close the opening of the heating system 100 and down to expose the opening of the heating system 100. Referring to FIG. 1, the door 112 is being hinged at a lower side of the case 110 at a front side of the case 110.

However, the exemplary embodiment is not limited thereto. The door 112 may be rotatably coupled to the case 110 and/or the inner frame 130 to be rotated in left and right directions, such as by being coupled with a side of the case 110.

A control unit 140 may be disposed or formed at an upper side of the front case 110. With the door 112 in a closed position to close the opening of the electric oven 100, the control unit 140 is disposed at an upper side of the door 112. The control unit 140 is configured to control operation of the electric oven 100 and may otherwise be referred to as a “controller.” The control unit 140 may collectively include a display unit 142 that is configured to display details about an operation state of the electric oven 100, a control button 144, and a control switch 146. The control buttons 144 and the control switch 146 are configured to be actuated to control and/or change an operation of the electric oven 100, the operation state of which is displayed by the display unit 142. The display unit 142 may hereinafter be referred to as an image display and may include a display screen or window at which an image is visible outside the electric oven 100 to communicate the operation state of the electric oven 100.

The inner frame 130 which defines the cavity 120 is spaced apart from the case 100 by a predetermined gap. The inner frame 130 may define sidewalls at the cavity 120. Guide rails 134 that support a rack 132 may be disposed on both sidewalls of the inner frame 130 that face each other with respect to the cavity 120. An object to be heated is placed on the rack 132 within the cavity 120 and may remain on the rack 132 during heating. A plurality of guide rails 134 may be provided along a height (vertical direction in FIG. 1) of the sidewalls to facilitate an object to be heated in the middle of cavity 120 along the height direction, according to the size of the object.

The inner frame 130 may include carbon steel. A first coating 136 (refer to FIG. 3) may be disposed on an inner surface of the inner frame 130. A second coating 138 (refer to FIG. 3) may be disposed on an external surface of the inner frame 130.

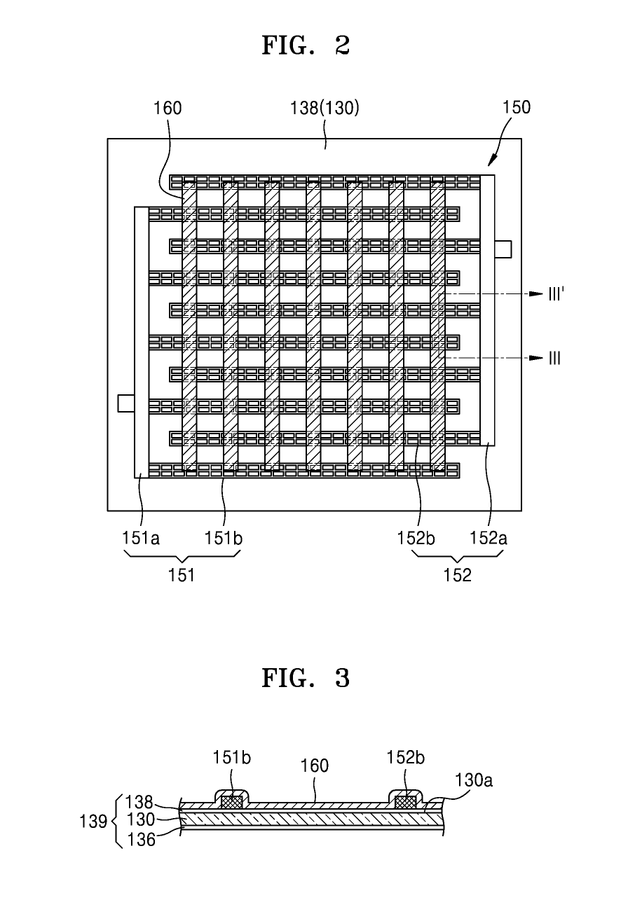

FIG. 2 is a schematic top plan view showing a disposition of a sheet heater 150 of the heating system as represented by an electric oven 100 according to an exemplary embodiment. The sheet heater 150 is configured to provide heat to the cavity 120. The sheet heater 150 may generate the heat provided to the cavity 120. The sheet heater 150 is disposed in a plane defined by first and second directions (e.g., vertical and horizontal in FIG. 2), so as to define an overall sheet shape. The top plan view is taken in a direction normal to the plane defined by the first and second directions.

The inner frame 130 may have a substantially cuboid shape. Among surfaces of the cuboid shape, one surface defines an opening, and the remaining five surfaces may not define an opening, such as being solid. At least one sheet heater 150 may be arranged on an external surface (refer to 130a of FIG. 3) of the inner frame 130. In FIG. 2, one sheet heater 150 is depicted as being arranged on the external surface 130a of the inner frame 130, but the exemplary embodiment is not limited thereto. In an alternative exemplary embodiment, for example, the sheet heater 150 may be provided in plurality arranged on the external surface 130a of the inner frame 130.

FIG. 3 is a cross-sectional view of a portion of the sheet heater of the heating system as represented by the electric oven taken along line III-III′ of FIG. 2.

Referring to FIGS. 2 and 3, the sheet heater 150 collectively includes a first electrode 151 and a second electrode 152 on a (base) substrate 139. The first electrode 151 includes a first main electrode 151a, and a first finger electrode 151b provided in plurality. The first electrode 151 and the second electrode 152 may each be disposed in a plane parallel to that defined by first and second directions (e.g., vertical and horizontal in FIG. 2). A cross-sectional view (e.g., thickness direction) is taken in a direction normal to the plane defined by the first and second directions.

The first main electrode 151a defines a length thereof extending in a first direction (vertical in FIG. 2). The first finger electrodes 151b respectively define lengths thereof extending in a second direction (horizontal in FIG. 2) from the first main electrode 151a. The first finger electrodes 151b may extend from a common one of the first main electrode 151a. The second electrode 152 includes a second main electrode 152a, and a second finger electrode 152b provided in plurality. The second main electrode 152a defines a length thereof extending in the first direction. The second finger electrodes 152b respectively define lengths thereof extending in the second direction towards the first main electrodes 151a. The second finger electrodes 152b may extend from a common one of the second main electrode 152a. The first finger electrodes 151b and the second finger electrodes 152b are alternately arranged in the first direction of FIG. 2.

The substrate 139 may collectively include the inner frame 130, the first coating 136 on the inner frame 130 and the second coating 138 on the inner frame 130. The first coating 136 may be disposed on a surface of the inner frame 130 facing the cavity 120. The inner frame 130 may include carbon steel. The first coating 136 may include enamel. The second coating 138 may be disposed on a surface of the inner frame 130 facing away from the cavity 120. The second coating 138 may include an insulating material, for example, enamel.

The first electrode 151 and the second electrode 152 may include Ag, Pt or Pd. Also, the first electrode 151 and the second electrode 152 may be an Ag alloy metal including a minor metal such as Pt or Pd. The first electrode 151 and the second electrode 152 may have a thickness in a range from about 10 micrometers (μm) to about 20 μm. The thickness is taken in a direction normal to a surface on which the respective coating is disposed.

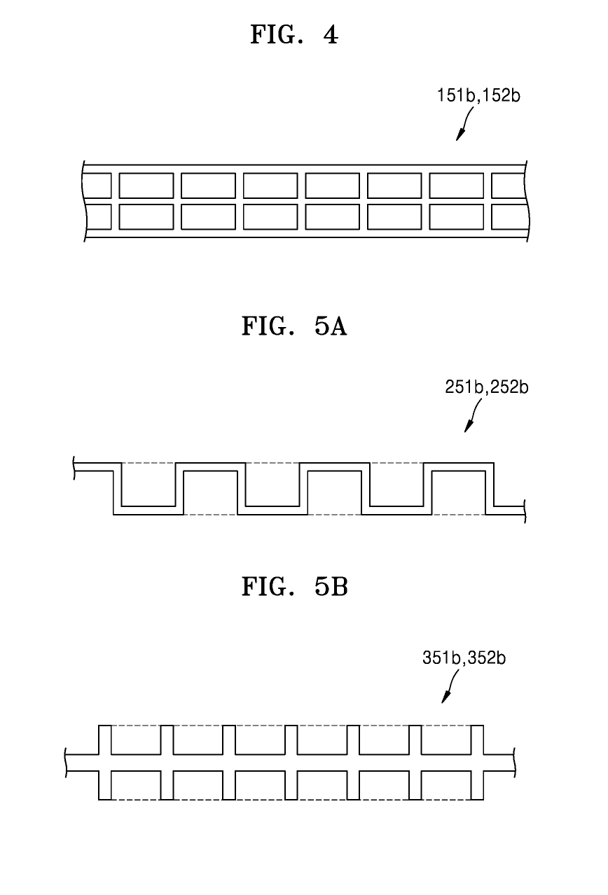

FIG. 4 is a schematic top plan view showing a structure of electrodes of a sheet heater of a heating system according to an exemplary embodiment.

Referring to FIG. 4, individual ones of the first finger electrodes 151b and/or the second finger electrodes 152b may be a pattern electrode. In an exemplary embodiment of forming a pattern electrode in manufacturing a sheet heater, a solid material layer may be processed such as by patterning to remove a predetermined region of the solid material layer to form enclosed openings. Referring to FIG. 4, for example, the first finger electrodes 151b and the second finger electrodes 152b may be a mesh shape formed by solid portions alternating with openings. A total planar area of the pattern electrode is defined by maximum overall dimensions of the whole pattern electrode. For the mesh shape, each of the solid portions and the openings occupy a portion of the total planar area of the pattern electrode.

In an exemplary embodiment, the first finger electrodes 151b and the second finger electrodes 152b may have an opening ratio in a range from about 40% to about 80%. For the mesh shape, the opening ratio denotes a ratio of a planar area occupied by the openings with respect to a planar area of the whole electrode. If the opening ratio is smaller than 40%, tensile stress in a heating layer 160 (refer to FIG. 3) may be increased. If the opening ratio is greater than 80%, an adhesion force between the first and second finger electrodes 151b and 152b and the heating layers 160 may be reduced, and thus, rigidity of the first finger electrodes 151b and the second finger electrodes 152b may be reduced.

Referring to FIGS. 2-4, the heating layer 160 crosses the first and second finger electrodes 151b and 152b at respective regions thereof. A total planar area of each region crossed by the heating layer 160 is defined by a product of an entire width of the heating layer 160 in the top plan view at the region and an entire width of the respective finger electrode in the top plan view at the region. The widths are taken perpendicular to the length of the respective element. Within the overall region at which the heating layer 160 crosses the finger electrode, both a solid portion and an opening of the finger electrode may be crossed by the heating layer 160.

FIGS. 5A and 5B are respectively schematic top plan views showing shapes of an electrode of a sheet heater of a heating system according to other exemplary embodiments. Referring to FIGS. 5A and 5B, individual ones of the first finger electrodes 251b and 351b and/or second finger electrodes 252b and 352b may have a structure in which at least one side thereof in the top plan view is open to have an open structure different from the enclosed structure of FIG. 4.

A total planar area of the pattern electrodes in FIGS. 5A and 5B is defined by maximum overall dimensions of the whole pattern electrode.

For the open structure, opening ratios of the first finger electrodes 251b and 351b and/or second finger electrodes 252b and 352b are calculated assuming that openings are surrounded by solid portions (e.g., solid lines in FIG. 4) and by outer edges of the overall pattern electrode (e.g., dotted lines in FIG. 4). Each of the solid portions and the openings in the open structure occupy a portion of the total planar area of the pattern electrode. In an exemplary embodiment, the first finger electrodes 251b and 351b and/or second finger electrodes 252b and 352b may have an opening ratio in a range from about 40% to about 80%, but the invention is not limited thereto.

Referring back to FIGS. 2 and 3, the heating layers 160 may be provided in plurality arranged on the second coating 138 and on respective finger electrodes. The heating layer 160 may be disposed in a plane parallel to that defined by first and second directions (e.g., vertical and horizontal in FIG. 2). A cross-sectional view (e.g., thickness direction) is taken in a direction normal to the plane defined by the first and second directions. The sheet heater 150 as including the first electrode 151, the second electrode 152 and the heating layer 160 is mounted on an external side of the inner frame 130, such as that side facing the case 110.

The heating layers 160 cover the first finger electrodes 151b and the second finger electrodes 152b to dispose the first finger electrodes 151b and the second finger electrodes 152b between the heating layers 160 and the second coating 138, and to dispose the second coating 138 between the heating layers 160 and the inner frame 130. The heating layers 160 may be discrete elements which are spaced apart from each other in the top plan view. The heating layers 160 respectively define lengths thereof extended in the first direction (vertical in FIG. 2). The heating layers 160 may be lengthwise arranged across the first finger electrodes 151b and the second finger electrodes 152b which alternate with each other in the first direction. The length of a single one heating layer 160 may be common to more than one first finger electrode 151b and more than one second finger electrode 152b, such as being common to all of the first and second finger electrodes 151b and 152b. Portions of the first finger electrodes 151b and the second finger electrodes 152b are exposed by the spaced apart heating layers 160, as illustrated in FIG. 2. The heating layers 160 may have a stripe shape as a discrete element.

Heat may be generated by the heating layers 160 such as by an electrical current applied to the first electrode 151 and the second electrode 152 which are in contact with the heating layer 160. That is, from the electrical current signal applied to the first electrode 151 and/or the second electrode 152, the sheet heater 150 may generate and provide heat.

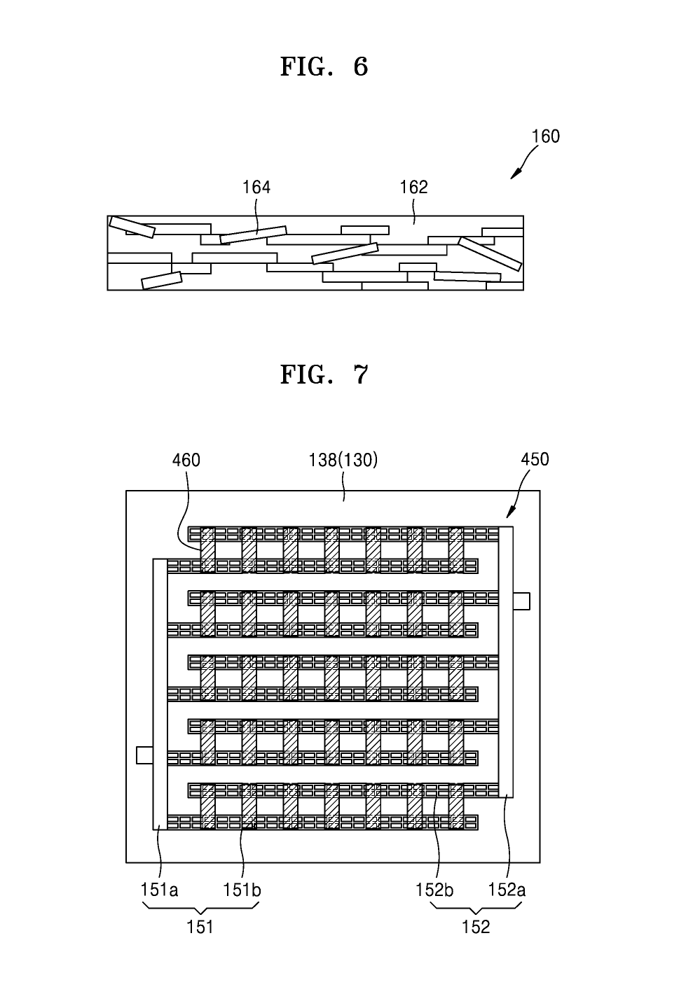

FIG. 6 is a cross-sectional view showing a structure of a heating layer 160 of a sheet heater of a heating system according to an exemplary embodiment.

Referring to FIG. 6, the heating layer 160 may include a matrix material or layer 162 and a filler 164 which is provided in plurality distributed in the matrix 162. The heating layer 160 may be considered a substantially solid member, such as having minimal or no openings defined therein in the top plan view. Adjacent fillers 164 within the matrix 162 may contact each other. Portions of the heating layer 160 lengthwise extend between the first finger electrodes 151b and the second finger electrodes 152b spaced apart from each other in the top plan view, to not be disposed over the finger electrodes. At these portions of the heating layer 160, the adjacent fillers 164 between the first finger electrodes 151b and the second finger electrodes 152b spaced apart from each other in the top plan view, may form an electrical current path between the first finger electrodes 151b and the second finger electrodes 152b, by the adjacent fillers 164 contacting each other. Accordingly, the heating layer 160 including the contacting adjacent fillers 164 has electrical conductivity. The heating layers 160 lengthwise extended between the first finger electrodes 151b and the second finger electrodes 152b may generate heat by a voltage applied to the first electrode 151 and the second electrode 152 owing to the electrical current applied thereto.

The matrix 162 may include a glass material such as a glass frit. The glass frit may include at least one oxide of, for example, silicon oxide, lithium oxide, nickel oxide, cobalt oxide, boron oxide, potassium oxide, aluminum oxide, titanium oxide, manganese oxide, copper oxide, zirconium oxide, phosphorus oxide, zinc oxide, bismuth oxide, lead oxide, and sodium oxide.

According to another exemplary embodiment, the matrix 162 may include an organic material having heat resistance, for example, an organic polymer. The organic polymer may have a melting temperature Tm of, for example, higher than about 200 degrees Celsius (° C.). The organic polymer may be one of polyimide (“PI”), polyphenylenesulfide (“PPS”), polybutylene terephthalate (“PBT”), polyamideimide (“PAI”), liquid crystalline polymer (“LCP”), polyethylene terephthalate (“PET”), polyphenylene sulfide (“PPS”) and polyetheretherketone (“PEEK”).

The fillers 164 may each have a shape to be considered a conductive sheet. The fillers 164 may have a composition having a given electrical conductivity (for example, about 1250 siemens per meter, “S/m”). However, the electrical conductivity of the fillers 164 may be smaller or greater than about 1250 S/m.

The conductive sheet fillers 614 having a sheet shape may include at least one of oxide, boride, carbide and chalcogenide.

Oxides used for the fillers 164 may be, for example, RuO₂, MnO₂, ReO₂, VO₂, OsO₂, TaO₂, IrO₂, NbO₂, WO₂, GaO₂, MoO₂, InO₂, CrO₂ or RhO₂.

Borides used for the fillers 164 may be, for example, Ta₃B₄, Nb₃B₄, TaB, NbB, V₃B₄ or VB.

Carbides used for the fillers 164 may be, for example, Dy₂C or Ho₂C.

Chalcogenides used for the fillers 164 may be, for example, AuTe₂, PdTe₂, PtTe₂, YTe₃, CuTe₂, NiTe₂, IrTe₂, PrTe₃, NdTe₃, SmTe₃, GdTe₃, TbTe₃, DyTe₃, HoTe₃, ErTe₃, CeTe₃, LaTe₃, TiSe₂, TiTe₂, ZrTe₂, HfTe₂, TaSe₂, TaTe₂, TiS₂, NbS₂, TaS₂, Hf₃Te₂, VSe₂, VTe₂, NbTe₂, LaTe₂ or CeTe₂.

Dimensions of the fillers 164 may vary according to a material used therefor. When a RuO₂ sheet is used as the fillers 164 of the heating layer 160, a minimum dimension (e.g., a thickness) of the fillers 164 may be in a range from about 0.1 nanometer (nm) to about 100 nanometers (nm). A maximum dimension (e.g., a length) of the fillers 164 may be in a range from about 1 μm to about 2 μm. The content of the fillers 164 in the heating layer 160 may be in a range from about 0.6 volume percent (vol %) to 1.0 vol % with respect to a total volume of the heating layer 160.

FIG. 7 is a schematic top plan view showing a disposition of a sheet heater 450 of a heating system according to another exemplary embodiment. Like reference numerals are used to indicate elements that are substantially identical to the elements of FIG. 2, and thus the detailed description thereof will not be repeated.

Referring to FIG. 7, the sheet heater 450 includes a heating layer 460 provided in plurality. Each of the heating layers 460 may be disposed or formed to contact corresponding first finger electrodes 151b and second finger electrodes 152b. The heating layers 460 may be arranged in an array type, such as being disposed in rows and columns in the top plan view. The length of a single one heating layer 160 may be common to only one first finger electrode 151b and only one second finger electrode 152b among a pair of adjacent first and second finger electrodes 151b and 152b. In the first direction (vertical in FIG. 2), a column of heating layers 460 may be disposed discontinuously with each other, since they are separated from each other along the length direction of the column. However, the exemplary embodiment is not limited thereto.

In an exemplary embodiment of manufacturing a sheet heater, the heating layers 460 may be formed by separating such as by cutting the stripe shaped heating layers 160 of FIG. 2 into a plurality of separated portions. Accordingly, respective tensile stress between the first and second finger electrodes 151b and 152b, and the heating layers 460, may be reduced.

In a sheet heater according to one or more exemplary embodiment, a contact area between pattern electrodes and heating layers thereon is reduced. Thus, with the reduced contact area, tensile stress of the heating layers due to expansion coefficient difference between the contacting heating layers and the pattern electrodes is reduced. As a result, the lifetime of the heating layers is increased.

Also, in an electric oven as representing a heating system or apparatus according to one or more exemplary embodiment, damage to the heating layers of the sheet heater is reduced even where the electric oven uses a relatively high temperature to heat objects therein. Also, owing to the sheet heater having the pattern electrodes and heating layers thereon in a sheet shape, a temperature distribution in a cavity of the display system or apparatus such as the electric oven is uniform, and thus, the lifetime of the display system or apparatus is increased.

While one or more embodiments have been described with reference to the figures, it will be understood by those of ordinary skill in the art that various changes in form and details may be made therein without departing from the spirit and scope as defined by the following claims.

What is claimed is:

1. A sheet heater of a heating apparatus, comprising:
a substrate within the heating apparatus, the substrate disposed a plane defined by first and second directions which cross each other;
a first electrode including a first finger electrode which is on the substrate to lengthwise extend in the first direction;
a second electrode including a second finger electrode which is on the substrate to lengthwise extend in the first direction, the second finger electrode spaced apart from the first finger electrode in the second direction; and
a heating layer in which heat is generated, the heating layer on the substrate to have a stripe shape lengthwise extended in the second direction to cross each of the first finger electrode and the second finger electrode,
wherein
the first finger electrode or the second finger electrode crossed by the heating layer is a pattern electrode in which an opening is defined,
for the pattern electrode in which the opening is defined, an opening ratio is defined by a total planar area of the opening to a total planar area of the pattern electrode, and
the opening ratio is in a range from about 40% to about 80%.

2. The sheet heater of claim 1, wherein the pattern electrode crossed by the heating layer has a mesh shape.

3. The sheet heater of claim 1, wherein the pattern electrode crossed by the heating layer includes Ag, Pt or Pd.

4. The sheet heater of claim 1, wherein
the first electrode and the second electrode respectively include the first finger electrode and the second finger electrode provided in plurality, the pluralities of the first and second finger electrodes alternated with each other in the second direction,
the heating layer is provided in plurality on the substrate, and
a single one of the heating layers crosses only one of the plurality of first finger electrodes and only one of the plurality of second finger electrodes.

5. The sheet heater of claim 1, wherein the pattern electrode crossed by the heating layer has a thickness in a range from about 10 micrometers to about 20 micrometers.

6. The sheet heater of claim 1, wherein the heating layer which crosses each of the first finger electrode and the second finger electrode includes:
a conductive filler sheet provided in plurality configured to form an electrical current path, and
a matrix in which the plurality of conductive filler sheets are disposed, the matrix including a glass frit or an organic polymer.

7. The sheet heater of claim 6, wherein each of the plurality of conductive filler sheets in the heating layer of the sheet heater defines a maximum dimension in a range from about 1 micrometer to about 2 micrometers.

8. The sheet heater of claim 6, wherein each of the plurality of conductive filler sheets in the heating layer of the sheet heater includes RuO₂, MnO₂, ReO₂, VO₂, OsO₂, TaO₂, IrO₂, NbO₂, WO₂, GaO₂, MoO₂, InO₂, CrO₂ or RhO₂.

9. The sheet heater of claim 6, wherein
each of the plurality of conductive filler sheets in the heating layer of the sheet heater includes RuO₂, and
a content of the plurality of conductive filler sheets each including RuO₂ is in a range from about 0.6 vol % to about 1.0 vol % with respect to a total volume of the heating layer.

10. The sheet heater of claim 1, wherein the heating layer which crosses each of the first finger electrode and the second finger electrode has a thickness in a range from about 5 micrometers to about 50 micrometers.

11. A heating system comprising:
a case of a heating apparatus of the heating system, the case having a rectangular box shape in which a front face thereof includes an opening through which an object to be heated is accommodated;
an inner frame in the case, the inner frame defining a cavity in which the object to be heated is accommodated; and
a sheet heater mounted on an external side of the inner frame, the external side facing the case,
wherein the sheet heater comprises on the external side of the inner frame:
an insulating layer on the inner frame;
a first electrode including a first finger electrode which is on the insulating layer to lengthwise extend in a first direction;
a second electrode including a second finger electrode which is on the insulating layer to lengthwise extend in the first direction, the second electrode spaced apart from the first electrode in a second direction which crosses the first direction; and
a heating layer in which heat is generated, the heating layer on the substrate to have a stripe shape lengthwise extended in the second direction to cross each of the first finger electrode and the second finger electrode,
wherein
the first finger electrode or the second finger electrode crossed by the heating layer is a pattern electrode in which an opening is defined,
for the pattern electrode in which the opening is defined, an opening ratio is defined by a total planar area of the opening to a total planar area of the pattern electrode, and
the opening ratio is in a range from about 40% to about 80%.

12. The heating system of claim 11, wherein the pattern electrode crossed by the heating layer has a mesh shape.

13. The heating system of claim 11, wherein the pattern electrode crossed by the heating layer includes Ag, Pt, or Pd.

14. The heating system of claim 11, wherein
the first electrode and the second electrode respectively include the first finger electrode and the second finger electrode provided in plurality, the first and second finger electrodes alternated with each other in the second direction,
the heating layer is provided in plurality on the substrate, and
a single one of the heating layers crosses only one of the plurality of first finger electrodes and only one of the plurality of second finger electrodes.

15. The heating system of claim 11, wherein the pattern electrode crossed by the heating layer has a thickness in a range from about 10 micrometers to about 20 micrometers.

16. The heating system of claim 11, wherein the heating layer which crosses each of the first finger electrode and the second finger electrode includes:
a conductive filler sheet provided in plural configured to form an electrical current path, and
a matrix in which the plurality of conductive filler sheets are disposed, the matrix including a glass frit or an organic polymer.

17. The heating system of claim 16, wherein each of the plurality of conductive filler sheets in the heating layer of the sheet heater defines a maximum dimension in a range from about 1 micrometer to about 2 micrometers.

18. The heating system of claim 16, wherein each of the plurality of conductive filler sheets in the heating layer of the sheet heater includes RuO₂, MnO₂, ReO₂, VO₂, OsO₂, TaO₂, IrO₂, NbO₂, WO₂, GaO₂, MoO₂, InO₂, CrO₂ or RhO₂.

19. The heating system of claim 16, wherein
each of the plurality of conductive filler sheets in the heating layer of the sheet heater includes RuO₂, and
a content of the plurality of conductive filler sheets each including RuO₂ is in a range from about 0.6 volume percent to about 1.0 volume percent with respect to a total volume of the heating layer.

20. The heating system of claim 11, wherein the heating layer which crosses each of the first finger electrode and the second finger electrode has a thickness in a range from about 5 micrometers to about 50 micrometers.

21. The sheet heater of claim 1, wherein the heating layer which crosses the pattern electrode contacts the pattern electrode at a crossed region thereof.

22. The sheet heater of claim 1, wherein
the pattern electrode includes a solid portion thereof which defines the opening, and
the crossed region of the pattern electrode at which the heating layer contacts the pattern electrode includes both the solid portion and the opening.

23. The sheet heater of claim 1, wherein the heating apparatus is an electric oven.

24. The heating system of claim 11, wherein the heating apparatus is an electric oven.
